(19) United States
(12) Patent Application Publication
(10) Pub. No.: US 2026/0166670 A1
(43) Pub. Date: Jun. 18, 2026

(54) SANDER

(71) Applicant: MAKITA CORPORATION, Anjo-shi (JP)

(72) Inventors: Yuga KUMAKIRI, Anjo-shi (JP); Tsuyoshi Kuroda, Anjo-shi (JP); Hiromu Goto, Anjo-shi (JP)

(73) Assignee: MAKITA CORPORATION, Anjo-shi (JP)

(21) Appl. No.: 19/395,151

(22) Filed: Nov. 20, 2025

(30) Foreign Application Priority Data
Dec. 13, 2024 (JP) 2024-218342

(51) Int. Cl. B24B 23/02; B24B 55/10; B25F 5/02

(52) U.S. Cl. CPC B24B 23/02; B24B 55/102; B25F 5/02

(57) ABSTRACT

A sander includes a pad, a motor, a main housing, a terminal assembly, and a support housing. The pad includes an attachment surface for attaching sanding paper, and is configured to perform an eccentric circular motion. The motor includes a motor shaft extending in a direction orthogonal to the attachment surface, and is configured to provide a driving force to the pad. The main housing is located above the pad, and contains the motor therein. The terminal assembly includes a terminal block, and a terminal supported on the terminal block so as to be partially exposed outward and electrically connectable to a battery. The terminal extends upward from the terminal block. The support housing protrudes from the main housing outward in a direction orthogonal to the up-down direction, and supports the terminal assembly.

### TECHNICAL FIELD

The present disclosure relates to a sander.

### BACKGROUND

Conventionally, there have been known battery-powered sanders configured to sand a workpiece by an eccentric circular motion. Such a sander can sand the workpiece by pressing sanding paper attached to a pad against the workpiece with the pad in an eccentric circular motion. For example, Japanese Patent Application Laid Open No. 2013-129014 discloses a sander in which a motor including a motor shaft extending in a direction orthogonal to a pad is contained in a housing, and a battery is attached to the side of the housing. The battery is oriented in such a manner that the longitudinal direction thereof intersects with the extension direction of the motor shaft at a small angle. Further, Japanese Patent Application Laid-Open No. 2022-17113 discloses a sander in which a motor including a motor shaft extending in a direction orthogonal to a pad is contained in a housing, and a battery is attached to the upper portion of the housing.

### SUMMARY

The present specification discloses a sander. This sander includes a pad, a motor, a main housing, a terminal assembly, and a support housing. The pad includes an attachment surface for attaching sanding paper, and is configured to perform an eccentric circular motion. The motor includes a motor shaft extending in a direction orthogonal to the attachment surface, and is configured to provide a driving force to the pad. The main housing is located above the pad when an up-down direction is defined to be a direction in which the motor shaft extends, a lower side is defined to be one side in the up-down direction on which the pad is located, and an upper side is defined to be the other side in the up-down direction on which the motor is located. The main housing contains the motor therein. The terminal assembly includes a terminal block, and a terminal supported on the terminal block so as to be partially exposed outward and electrically connectable to a battery. The terminal extends upward from the terminal block. The support housing protrudes from the main housing outward in a direction orthogonal to the up-down direction, and supports the terminal assembly.

Extending “upward” includes extending in parallel with the up-down direction, and having component in the up-down direction directed from a lower side toward an upper side while extending in a direction intersecting with the up-down direction.

According to this sander, the support housing, which protrudes from the main housing outward in the direction orthogonal to the up-down direction, supports the terminal assembly. In other words, the battery is mounted on the support housing protruding from the main housing outward in the direction orthogonal to the up-down direction. Therefore, the main housing can be downsized in the up-down direction. A top portion of the main housing may function as a grip portion gripped by a user at the time of sanding work. Downsizing the main housing in the up-down direction allows the grip portion to be located closer to the pad, thereby improving usability at the time of the sanding work. Further, the terminal of the terminal assembly extends upward from the terminal block, and this means that the battery is placed on the support housing. Therefore, the battery, which is high in height in the pose when being mounted, can be mounted without being subjected to constraints. Further, the support housing and the battery can also be downsized in the up-down direction with the battery mounted, by combining the present configuration with a configuration in which the battery is mounted in such a pose that the longitudinal direction of the battery is orthogonal to the up-down direction or intersects with the up-down direction at a large angle.

As will be used herein, the terms “up-down direction”, “front-rear direction”, and “left-right direction” are defined for convenience to illustrate a relative position of each component of the sander, and are not intended to limit the pose of the sander in use or the relative position in relation to the gravitational direction.

### BRIEF DESCRIPTION OF THE DRAWINGS

FIG. 1 is a perspective view of a sander according to a first embodiment.

FIG. 2 is a left side view of the sander.

FIG. 3 is a right side view of the sander.

FIG. 4 is a rear view of the sander.

FIG. 5 is a plan view of the sander.

FIG. 6 is a bottom view of the sander.

FIG. 7 is a right side view of the sander with a battery and a dust box removed therefrom.

FIG. 8 is a rear view of the sander with the battery and the dust box removed therefrom.

FIG. 9 is a perspective view of the sander with the battery and the dust box removed therefrom.

FIG. 10 is a perspective view of the battery.

FIG. 11 is a cross-sectional view of the sander taken along a line A-A illustrated in FIG. 2.

FIG. 12 is a cross-sectional view of the sander taken along a line B-B illustrated in FIG. 2.

FIG. 13 is a cross-sectional view of the sander taken along a line C-C illustrated in FIG. 4.

FIG. 14 is a cross-sectional view of the sander taken along a line D-D illustrated in FIG. 5.

FIG. 15 is a perspective view of a sander according to a second embodiment.

FIG. 16 is a cross-sectional view of the sander according to the second embodiment, and corresponds to FIG. 13.

FIG. 17 is a perspective view of a sander according to a third embodiment.

FIG. 18 is a rear view of the sander according to the third embodiment with the battery and the dust box removed therefrom.

FIG. 19 is a cross-sectional view of the sander according to the third embodiment, and corresponds to FIG. 13.

### DETAILED DESCRIPTION OF THE EMBODIMENTS

In the following description, representative and non-limiting specific examples of the present invention will be described in detail with reference to the drawings. This detailed description is merely intended to teach a person of skill in the art details for practicing preferred examples of the present invention and is not intended to limit the scope of the present invention. Furthermore, each of additional features and inventions disclosed below can be utilized separately from or together with other features and inventions to provide further improved apparatuses and methods for manufacturing and using the same.

Moreover, combinations of features and steps disclosed in the following detailed description are not necessary to practice the present invention in the broadest sense, and are instead taught merely to particularly describe a representative specific example of the present invention. Furthermore, various features of the above-described and the following representative examples, as well as various features recited in the independent and dependent claims below, do not necessarily have to be combined in herein specifically exemplified manners or enumerated orders to provide additional and useful embodiments of the present invention.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges and indications of groups or aggregations are intended to disclose every possible intermediate individual forming them for the purpose of original written disclosure, as well as for the purpose of restricting the claimed subject matter.

In one or more embodiments, the support housing may be located on the lower side with respect to an upper surface of the main housing in the up-down direction. According to this configuration, the battery can be disposed in a space defined due to a step generated in the up-down direction between the main housing and the support housing. Therefore, the support housing and the battery can be further downsized in the up-down direction with the battery mounted.

In one or more embodiments, the support housing may be located on the lower side with respect to an upper end of the motor shaft in the up-down direction. According to this configuration, the space defined in the up-down direction between the main housing and the support housing increases in size. Therefore, the support housing and the battery can be further downsized in the up-down direction with the battery mounted.

In one or more embodiments, the terminal may extend from the terminal block in parallel with the up-down direction. According to this configuration, the battery can be mounted in such an orientation that the height of the battery in the up-down direction reduces. Therefore, the support housing and the battery can be further downsized in the up-down direction with the battery mounted.

In one or more embodiments, the sander may include a controller contained in the support housing so as to be located below the terminal assembly and configured to control an operation of the sander. According to this configuration, the controller can be disposed in a dead space below the terminal assembly. Therefore, the sander is prevented from increasing in size due to the layout of the controller.

In one or more embodiments, the controller may be disposed so as to face the terminal block of the terminal assembly. According to this configuration, the terminal assembly and the controller can be disposed in a downsizing manner in the up-down direction.

In one or more embodiments, the sander may include the battery.

In one or more embodiments, an upper end surface of the battery may be located on the lower side with respect to an upper surface of the main housing in the up-down direction with the battery electrically connected to the terminal of the terminal assembly. According to this configuration, the battery can be completely disposed in a space defined due to a step generated in the up-down direction between the main housing and the support housing. Therefore, the support housing and the battery can be further downsized in the up-down direction with the battery mounted.

In one or more embodiments, when a front-rear direction is defined to be a direction in which the main housing and the support housing are arranged, and a left-right direction is defined to be a direction orthogonal to the up-down direction and the front-rear direction, a longitudinal direction of the battery may extend in parallel with the front-rear direction and the battery may be located at a position where the battery does not protrude outward beyond the pad in the left-right direction as viewed in the up-down direction with the battery electrically connected to the terminal of the terminal assembly. According to this configuration, when the sander is in use, even moving the pad closer to an obstacle such as a wall does not cause interference of the battery with the obstacle. Therefore, sanding work can be performed even at a location close to the obstacle.

In one or more embodiments, the sander may include a dust nozzle extending from the main housing. The dust nozzle may be located at a position where the dust nozzle does not overlap the battery as viewed in the up-down direction with the battery electrically connected to the terminal of the terminal assembly. According to this configuration, the heights of the support housing and the battery in the up-down direction do not increase due to the dust nozzle.

In one or more embodiments, the dust nozzle may be located at a position where the dust nozzle at least partially overlaps the support housing as viewed in a direction orthogonal to the up-down direction. According to this configuration, the heights of the support housing and the battery do not increase due to the dust nozzle.

In one or more embodiments, the dust nozzle may be located at a position where the dust nozzle at least partially overlaps the controller as viewed in a direction orthogonal to the up-down direction. According to this configuration, the heights of the support housing and the battery, and the vicinity thereof in the up-down direction do not increase due to the dust nozzle.

In one or more embodiments, as viewed in the up-down direction, the dust nozzle may extend in a direction intersecting with the direction in which the motor and the controller are arranged or be offset from the support housing in the direction orthogonal to the direction in which the motor and the controller are arranged.

According to this configuration, the heights of the support housing and the battery in the up-down direction do not increase due to the dust nozzle.

In one or more embodiments, the battery and the pad may partially overlap each other as viewed in the up-down direction with the battery electrically connected to the terminal of the terminal assembly. According to this configuration, the center of gravity of the sander is located closer to the pad with the battery mounted, compared with a configuration in which the battery and pad do not overlap each other as viewed in the up-down direction. Therefore, the user can further stably perform sanding work while gripping the main housing.

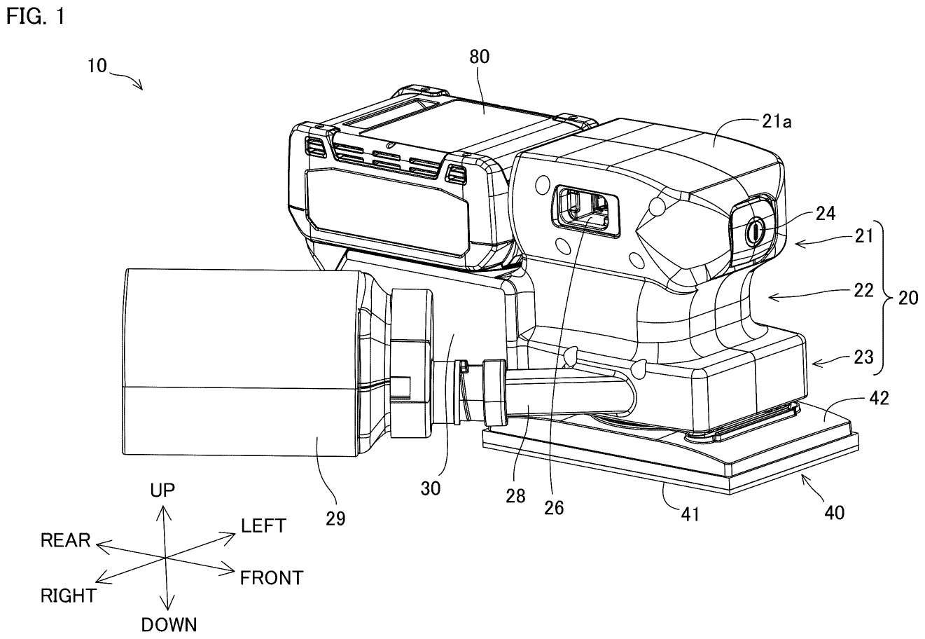

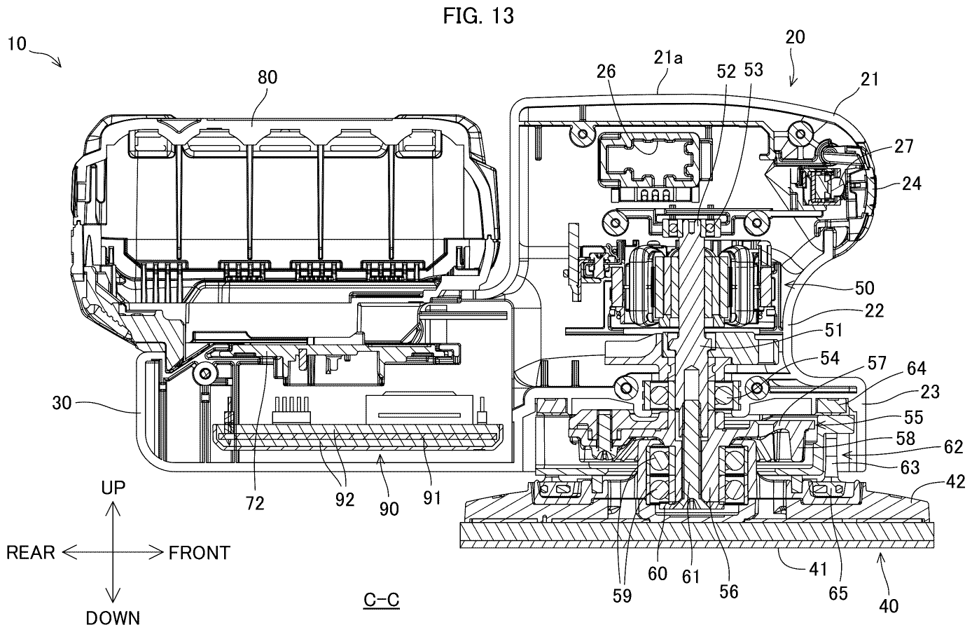

In the following description, a sander 10 according to a non-limiting first embodiment will be described in further detail with reference to FIGS. 1 to 14. The sander 10 is also referred to as an orbital sander. As illustrated in FIGS. 1 and 13, the sander 10 includes a main housing 20, a support housing 30, a pad 40, and a motor 50. The motor 50 includes a motor shaft 51, and is contained in the main housing 20. The pad 40 is operably coupled with the motor shaft 51. As will be described in detail below, the pad 40 performs a sanding motion using a rotational driving force of the motor 50. The support housing 30 protrudes from the main housing 20 outward in a direction orthogonal to a direction in which the motor shaft 51 extends.

In the following description, an up-down direction of the sander 10 is defined to be the direction in which the motor shaft 51 extends for convenience of the description. A lower side of the sander 10 is defined to be one side in the up-down direction on which the pad 40 is located, and an upper side of the sander 10 is defined to be the other side on which the motor 50 is located. Further, a front-rear direction of the sander 10 is defined to be a direction orthogonal to the up-down direction and a direction in which the main housing 20 and the support housing 30 are arranged. A front side of the sander 10 is defined to be one side in the front-rear direction on which the main housing 20 is located, and a rear side of the sander 10 is defined to be the other side on which the support housing 30 is located. Further, a left-right direction of the sander 10 is defined to be a direction orthogonal to the up-down direction and the front-rear direction. A right side of the sander 10 is defined to be a right side in the left-right direction when the front side is viewed from the rear side, and a left side of the sander 10 is defined to be an opposite side therefrom.

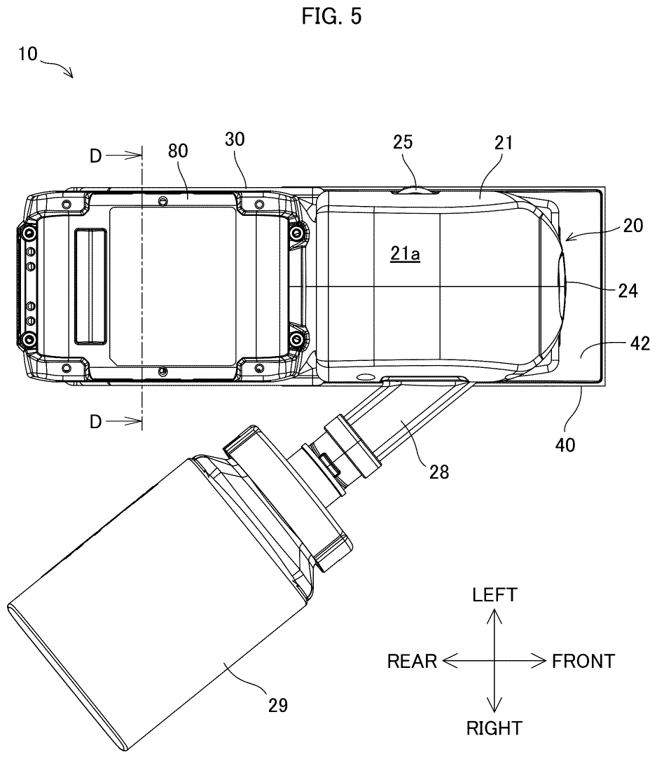

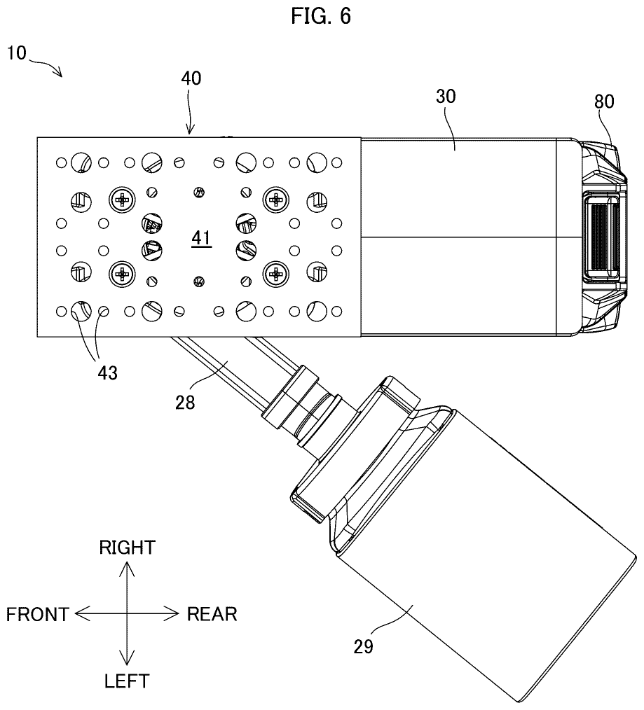

As illustrated in FIGS. 1 and 6, the pad 40 has a generally rectangular outer shape as viewed in the up-down direction. The pad 40 includes an attachment surface 41 for attaching sanding paper. The attachment surface 41 is a flat bottom surface of the pad 40, and expands in a direction orthogonal to the up-down direction. As illustrated in FIG. 6, the pad 40 includes a plurality of through-holes 43 extending in the up-down direction. As illustrated in FIG. 1, a base 42 is fixed on the pad 40. As illustrated in FIGS. 1 and 5, the base 42 is slightly smaller than the pad 40 and has an outer shape in conformity with the outer shape of the pad 40 as viewed in the up-down direction. The main housing 20 is located right above the pad 40 and the base 42.

As illustrated in FIG. 1, the main housing 20 includes a housing upper portion 21, a housing central portion 22, and a housing lower portion 23. The housing upper portion 21 and the housing lower portion 23 protrude more outward than the housing central portion 22 on the front side, the right side, and the left side thereof. The housing upper portion 21 functions as a grip portion gripped by a user when the sander 10 is in use. Most of the motor 50 is contained in the housing central portion 22.

As illustrated in FIG. 1, a switch button 24 is provided on the front surface of the housing upper portion 21. The switch button 24 is used to perform operations of starting up and stopping the motor 50. As illustrated in FIG. 13, a switch unit 27 is disposed in the rear of the switch button 24. The switch unit 27 is electrically connected to a controller 90, and detects a displacement of the switch button 24 that occurs due to an ON operation thereof and outputs it to the controller 90.

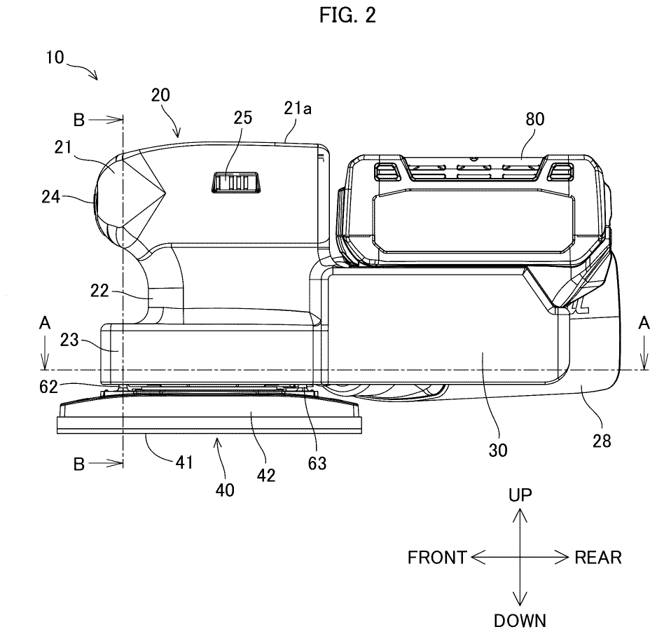

As illustrated in FIG. 2, a speed change dial 25 for changing the rotational speed of the motor 50 is provided on the left side surface of the housing upper portion 21. A displacement of the speed change dial 25 is detected by a displacement sensor (not illustrated). The displacement sensor is electrically connected to the controller 90, and outputs the displacement amount of the speed change dial 25 to the controller 90.

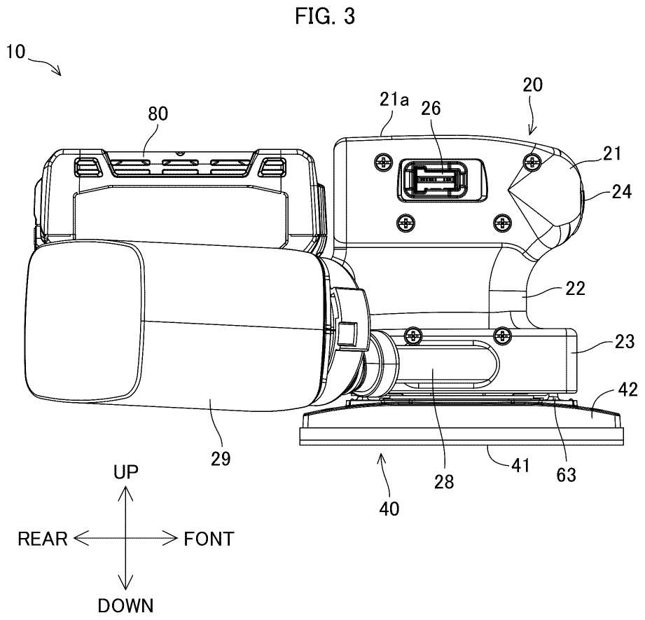

As illustrated in FIGS. 1 and 3, an electric connection portion 26 is provided on the right surface of the housing upper portion 21. The electric connection portion 26 is used to insert a wireless communication adapter (not illustrated) to electrically connect it. The electric connection portion 26 is electrically connected to the controller 90. The wireless communication adapter is configured to carry out Bluetooth communication in the present embodiment, but another communication method may be employed. The wireless communication adapter wirelessly communicates with another accessory equipment. The accessory equipment is, for example, a dust collector. The wireless communication allows operations of starting up and stopping the accessory equipment to be linked with operations of starting up and stopping the sander 10.

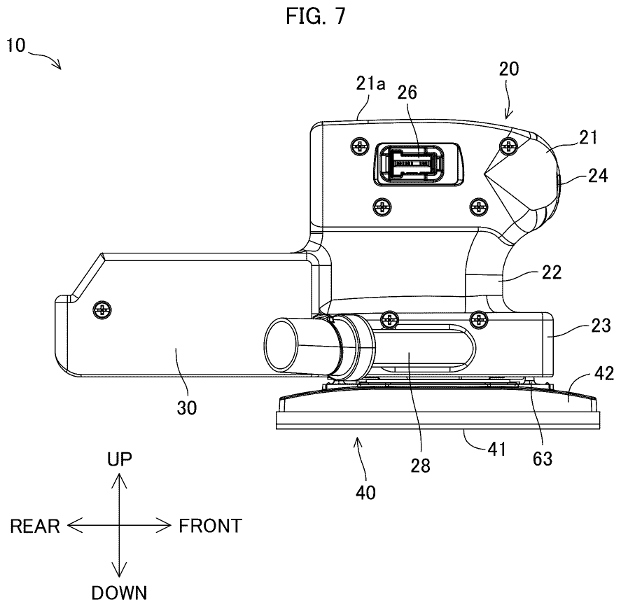

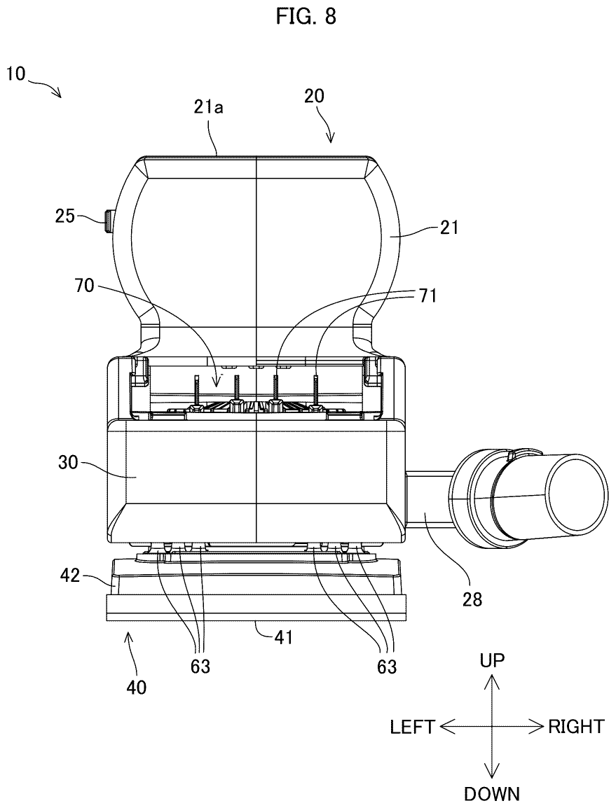

As illustrated in FIGS. 7 and 8, the support housing 30 is located on the lower side with respect to an upper surface 21a of the main housing 20 in the up-down direction in the present embodiment. More specifically, the support housing 30 extends rearward from the housing central portion 22 and the housing lower portion 23. Further, as illustrated in FIG. 13, the support housing 30 is located on the lower side with respect to an upper end 52 of the motor shaft 51 in the up-down direction in the present embodiment.

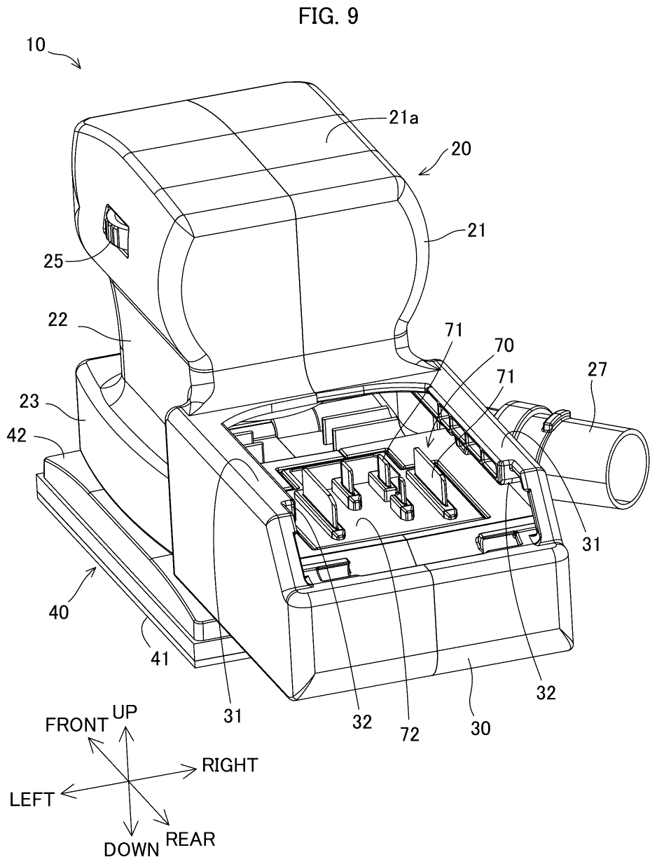

The support housing 30 has a generally cuboidal box-shape, and is opened on the upper side thereof. The edge portion of the support housing 30 on the rear side and upper side is cut out. As illustrated in FIG. 8, the support housing 30 is located inside with respect to the pad 40 in the left-right direction. As illustrated in FIGS. 8 and 9, the support housing 30 supports a terminal assembly 70 so as to expose it on the upper side thereof. A battery 80 is detachably mounted on the terminal assembly 70.

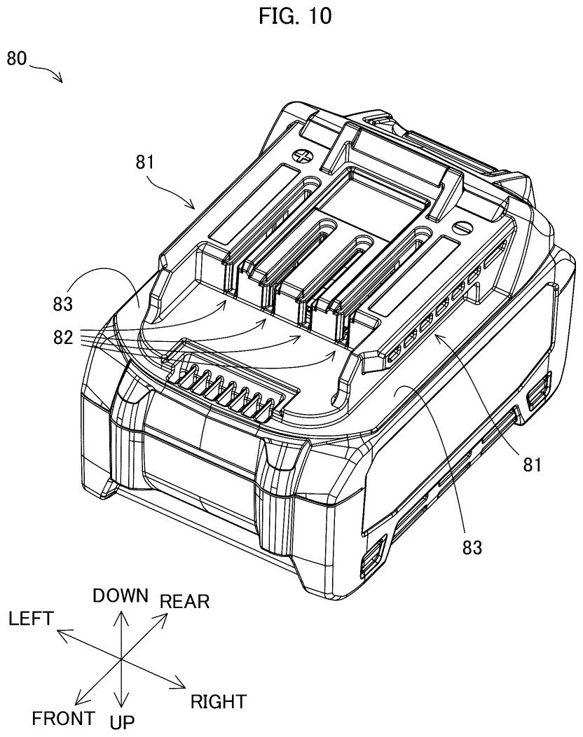

As illustrated in FIG. 10, the battery 80 has a generally cuboidal shape. The direction indicators illustrated in FIG. 10 indicate directions with the battery 80 mounted on the terminal assembly 70. The battery 80 includes two guide groove 81 and four terminal connection grooves 82 as one example of a connection interface (a mechanical and electric connection interface) with the support housing 30 and the terminal assembly 70. The guide grooves 81 are defined at both the edge portions in the left-right direction at the lower edge of the battery 80. Each of the guide grooves 81 extends in the front-rear direction so as to be opened on the outer side thereof in the left-right direction, and the rear end of the guide grooves 81 is closed and the front end of the guide grooves 81 is opened. The terminal connection grooves 82 are located between the two guide grooves 81. Each of the terminal connection grooves 82 extends in the front-rear direction so as to be opened on the lower side thereof, and the rear end of the terminal connection grooves 82 is closed and the front end of the terminal connection grooves 82 is opened. A terminal (not illustrated) for an electric connection to a terminal 71 (refer to FIG. 9) of the terminal assembly 70 is provided inside the terminal connection groove 82.

The battery 80 further includes two mounting surfaces 83. The mounting surfaces 83 are defined on both the end portions in the left-right direction. A part of each of the mounting surfaces 83 is located outside with respect to the guide groove 81 in the left-right direction, and the remaining portion thereof defines the guide groove 81.

As illustrated in FIGS. 8, 9, 13, and 14, the terminal assembly 70 includes a plurality of terminals 71 and a terminal block 72. Each of the terminals 71 is electrically connected to the battery 80 (more specifically, the terminal in the terminal connection groove 82) when the battery 80 is mounted on the terminal assembly 70. The terminal block 72 is generally shaped like a flat plate perpendicular to the up-down direction. The terminal block 72 supports the terminals 71 in such a manner that the terminals 71 are partially exposed outward. The terminals 71 extend from the terminal block 72 upward. In the present embodiment, the terminals 71 extend in parallel with the up-down direction. Further, each of the terminals 71 has a flat plate-shape, the thickness direction of which extends in the left-right direction.

As illustrated in FIG. 9, the support housing 30 includes placement surfaces 31 at the left-side and right-side edge portions thereof. The placement surfaces 31 are surfaces on which the battery 80 (more specifically, the mounting surfaces 83 of the battery 80) is placed, and are flatly defined. The placement surfaces 31 are orthogonal to the up-down direction. In the present embodiment, the placement surfaces 31 expand in the direction orthogonal to the up-down direction. The support housing 30 further includes two guide rails 32. The guide rails 32 extend in the front-rear direction along the two inner edge portions of the placement surfaces 31 in the left-right direction, respectively. The guide rails 32 on the both sides protrude inward in the left-right direction so as to face each other. The guide rails 32 are inserted into the guide grooves 81 of the battery 80 when the battery 80 is mounted.

Due to such a configuration, the battery 80 can be mounted on the support housing 30 by sliding it in the direction orthogonal to the up-down direction (more specifically, from the rear side to the front side). The support housing 30 and the terminal assembly 70 may be configured to allow the battery 80 to be detachably mounted by sliding the battery 80 in the left-right direction.

As illustrated in FIGS. 2 and 3, with the battery 80 mounted, the upper end surface of the battery 80 is located on the lower side with respect to the upper surface 21a of the main housing 20 in the up-down direction. Further, as illustrated in FIGS. 1 to 4, the longitudinal direction of the battery 80 extends in parallel with the front-rear direction. Further, as illustrated in FIGS. 5 and 6, the battery 80 is located at a position where it does not protrude outward beyond the pad 40 in the left-right direction. Further, as illustrated in FIG. 13, the battery 80 and the pad 40 partially overlap each other as viewed in the up-down direction.

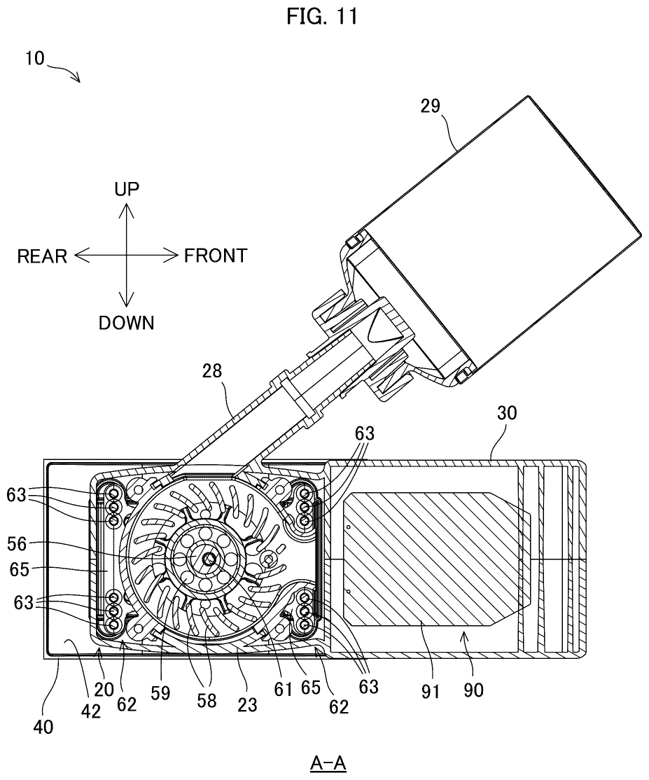

As illustrated in FIGS. 11, 13, and 14, the controller 90 is contained in the support housing 30. The controller 90 is located below the terminal assembly 70. The controller 90 controls the operation of the sander 10. For example, the controller 90 controls the operation of the motor 50 by controlling electric power supplied from the battery 80 to the motor 50. More specifically, the controller 90 starts up and stops the motor 50 based on a signal input from the switch unit 27. Further, the controller 90 controls the rotational speed of the motor 50 based on the operation on the speed change dial 25. The rotational speed may be controlled based on PWM control. Further, the controller 90 controls wireless communication between the wireless communication adapter and another accessory equipment when the wireless communication adapter is connected to the electric connection portion 26. In the present embodiment, the controller 90 includes a high temperature protection circuit, an over current protection circuit, and an over discharge protection circuit. However, one or two of these protection circuits may be omitted. The controller 90 may include a processor.

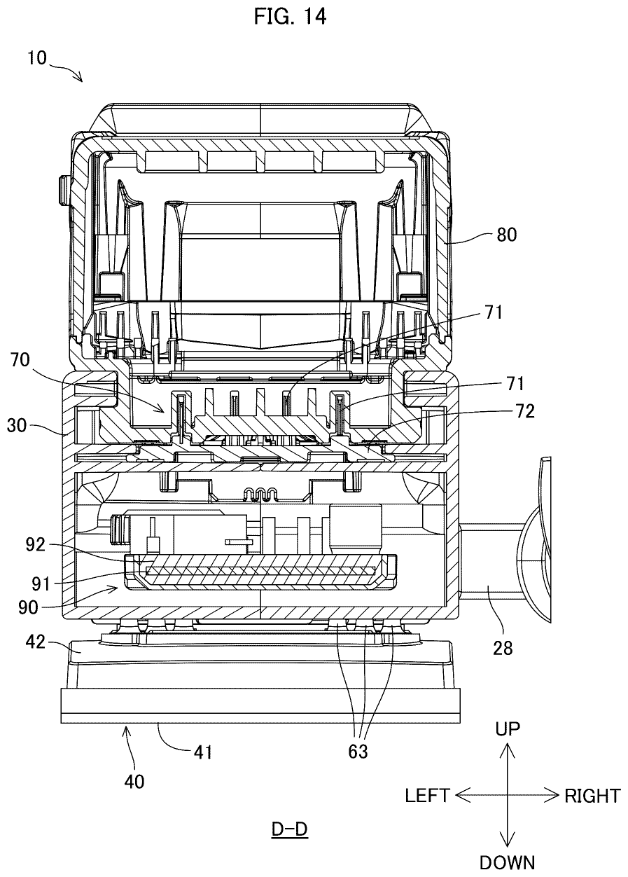

As illustrated in FIGS. 13 and 14, the controller 90 includes a circuit board 91 and a case 92 in the present embodiment. The case 92 is molding resin covering the entire circuit board 91. As illustrated in FIGS. 11, 13, and 14, the controller 90 has a plate-shape. In the present embodiment, the longitudinal direction of the controller 90 coincides with the front-rear direction. Further, the controller 90 is disposed in such a manner that the widest surface thereof faces the terminal block 72 of the terminal assembly 70. The controller 90 and the terminal block 72 face in parallel with each other in the present embodiment, but may face each other non-parallelly.

As illustrated in FIG. 13, the motor shaft 51 is rotatably supported by bearings 53 and 54 fixed to the housing 20. The bearing 53 supports the upper end 52 of the motor shaft 51, and the bearing 54 supports the vicinity of the rear end of the motor shaft 51.

As illustrated in FIG. 13, a dust collection fan 55 is attached around the motor shaft 51 below the bearing 54. The dust collection fan 55 is contained in the housing lower portion 23 of the main housing 20. The dust collection fan 55 includes a shaft portion 56, a main plate 57, and a plurality of blades 58. The shaft portion 56 is cylindrically shaped, and the lower end portion of the motor shaft 51 is inserted in the upper end portion of the shaft portion 56. The main plate 57 is a portion extending in a flange manner radially outward from near the upper end of the shaft portion 56. The plurality of blades 58 extends downward from the lower surface of the main plate 57. As illustrated in FIG. 11, the plurality of blades 58 are disposed at intervals in the circumferential direction.

As illustrated in FIG. 13, a portion of the shaft portion 56 on the lower side with respect to the main plate 57 is rotatably supported by two bearings 59 adjacent in the up-down direction. A plate 60 is in abutment with an inner race of one of the two bearings 59 that is located on the lower side. A countersunk screw 61 is disposed so as to extend through the plate 60 and the shaft portion 56 in the up-down direction and further extend through inside the lower end portion of the motor shaft 51, and is tightened. Due to that, the positional relationship is fixed between the motor shaft 51, the shaft portion 56, and the bearings 59. The countersunk screw 61 is coaxial with the motor shaft 51. The shaft portion 56 and the bearings 59 are eccentric with respect to the motor shaft 51.

As illustrated in FIGS. 11 to 13, the pad 40 and the base 42 are coupled with the housing lower portion 23 via two connectors 62. As illustrated in FIG. 11, the two connectors 62 are disposed at the front portion and the rear portion of the housing lower portion 23, respectively.

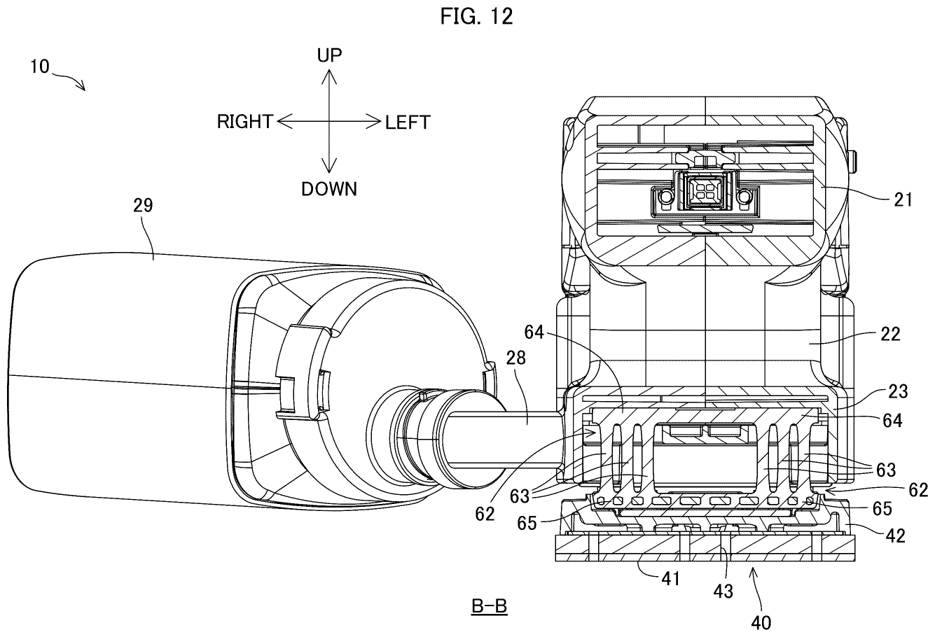

As illustrated in FIG. 12, the connector 62 located at the front portion of the housing lower portion 23 includes six foot portions 63, an upper plate 64, and a lower plate 65. The upper plate 64 and the lower plate 65 are spaced apart in the up-down direction, and extend in the left-right direction over almost the entire width of the housing lower portion 23 in the left-right direction. The upper plate 64 is fixed to the housing lower portion 23. The lower plate 65 is fixed to the base 42.

As illustrated in FIG. 12, the six foot portions 63 extend in the up-down direction to couple the upper plate 64 and the lower plate 65. Three of the foot portions 63 are located near the left edge portions of the upper plate 64 and the lower plate 65, and the remaining three foot portions 63 are located near the right edge portions of the upper plate 64 and the lower plate 65. The foot portions 63, the upper plate 64, and the lower plate 65 are an integral molded member, and are made from TPE (thermoplastic elastomer) in the present embodiment. The connector 62 located at the rear portion of the housing lower portion 23 is also configured similarly to the connector 62 located on the front portion, although the illustration thereof is omitted here.

The above-described sander 10 operates in the following manner. First, when the user operates the switch button 24 to drive the motor 50, the motor shaft 51 starts rotating. Since the bearings 59 and the shaft portion 56 of the dust collection fan 55 are eccentric with respect to the motor shaft 51, the rotation of the motor shaft 51 causes the pad 40 to perform an eccentric circular motion (an orbital motion) while changing horizontal relative positions between the top portions and the bottom portions of the foot portions 63 (i.e., while deforming the connectors 62 so as to change the inclination directions of the foot portions 63). In other words, the pad 40 does not rotate itself, and moves so as to draw a circle along the horizontal surface while keeping its pose. When the sanding paper attached to the bottom surface of the pad 40 is pressed against a workpiece in this state, the workpiece is sanded.

Dust generated along with the sanding can be collected into a dust bag 29. More specifically, as illustrated in FIGS. 1 and 3 to 6, the sander 10 includes a dust nozzle 28 extending from the housing lower portion 23. The inside of the dust nozzle 28 is in communication with the inside of the housing lower portion 23 (a space where the dust collection fan 55 is contained). The dust bag 29 is attached to the tip of the dust nozzle 28.

When the motor 50 rotates at the time of sanding work, the dust collection fan 55 attached to the motor shaft 51 rotates. Due to that, air including the dust generated due to the sanding passes through a hole of the sanding paper, the through-holes 43 of the pad 40, and a space inside the base 42, and flows into the housing lower portion 23. At this time, the air collides with the main plate 57 of the dust collection fan 55, and is guided radially outward due to the action of the blades 58. The air directed in this manner passes through the dust nozzle 28 and flows into the dust bag 29. The dust generated at the time of the sanding work can be collected into the dust bag 29 with the aid of this flow of air.

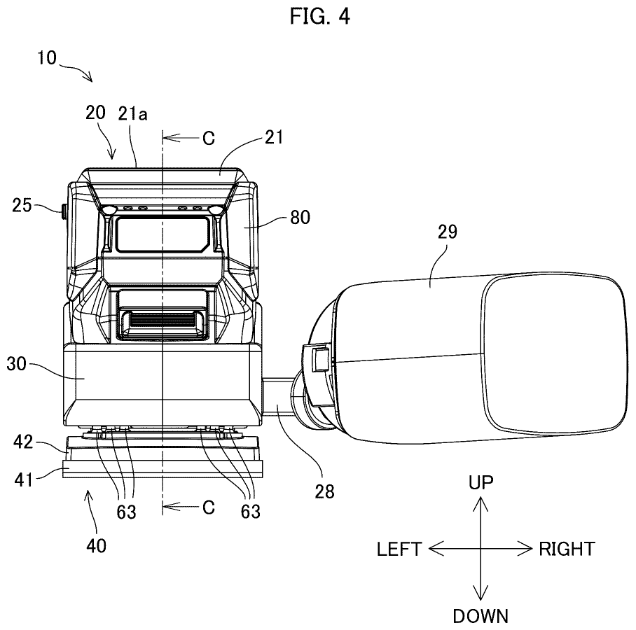

As illustrated in FIGS. 1 to 6, the dust nozzle 28 linearly extends from the right side surface of the housing lower portion 23 toward the rear side and the right side in the present embodiment. As illustrated in FIGS. 4 to 6, the dust nozzle 28 is located at a position where it does not overlap the battery 80 as viewed in the up-down direction with the battery 80 mounted. Therefore, the dust nozzle 28 and the dust bag 29 located on an extension thereof do not overlap the battery 80 and the support housing 30 in the up-down direction. In other words, the heights of the battery 80 and the support housing 30 in the up-down direction do not increase due to the dust nozzle 28.

Further, as illustrated in FIGS. 4, 7, and 8, the dust nozzle 28 is located at a position where it overlaps the support housing 30 as viewed in the front-rear direction.

This configuration also prevents the heights of the battery 80 and the support housing 30 in the up-down direction from increasing due to the dust nozzle 28. The dust nozzle 28 may be located at a position where it partially overlaps the support housing 30 as viewed in the front-rear direction.

Further, as illustrated in FIG. 14, the dust nozzle 28 is located at a position where it overlaps the controller 90 as viewed in the front-rear direction. This configuration also prevents the heights of the battery 80 and the support housing 30 in the up-down direction from increasing due to the dust nozzle 28. The dust nozzle 28 may be located at a position where it partially overlaps the controller 90 as viewed in the front-rear direction.

Further, the dust nozzle 28 extends in a direction intersecting with a direction (the front-rear direction in the present embodiment) in which the motor 50 and the controller 90 are arranged as viewed in the up-down direction. This configuration also prevents the heights of the battery 80 and the support housing 30 in the up-down direction from increasing due to the dust nozzle 28. The dust nozzle 28 may be offset from the support housing 30 in a direction (the left-right direction in the present embodiment) orthogonal to the direction in which the motor 50 and the controller 90 are arranged. For example, the dust nozzle 28 may extend from the right side surface of the housing lower portion 23 rightward or rightward and rearward, and, beyond that, extend in parallel with the support housing 30 (in the front-rear direction). This configuration can also bring about similar advantageous effects According to the above-described sander 10, the support housing 30, which protrudes from the main housing 20 outward in the front-rear direction, supports the terminal assembly 70. In other words, the battery 80 is mounted on the support housing 30 protruding from the main housing 20 outward in the front-rear direction. Therefore, the main housing 20 including the housing upper portion 21, which functions as the grip portion, can be downsized in the up-down direction without being affected by the size of the battery 80 in use. Downsizing the main housing 20 in the up-down direction allows the grip portion to be located closer to the pad, thereby improving the usability at the time of sanding work. Further, the terminals 71 of the terminal assembly 70 extend upward from the terminal block 72, and this means that the battery 80 is placed on the support housing 30. Therefore, the battery 80, which is high in height in the pose when being mounted, can be mounted without being subjected to constraints.

Especially, in the present embodiment, the terminals 71 of the terminal assembly 70 extend from the terminal block 72 in parallel with the up-down direction, and therefore the battery 80 can be mounted in such an orientation that the height of the battery 80 in the up-down direction reduces. In other words, the present embodiment allows the battery to be mounted in such a manner that the longitudinal direction of the battery 80 is orthogonal to the up-down direction by sliding the battery 80 in the direction orthogonal to the up-down direction. Therefore, the support housing 30 and the battery 80 can also be downsized in the up-down direction with the battery 80 mounted. The terminals 71 of the terminal assembly 70 may extend from the terminal block 72 non-parallelly with the up-down direction. In this case, the extension direction of the terminals 71 may be a direction intersecting with the up-down direction at an angle equal to or smaller than 30 degrees. Even in this case, the battery 80 can also be mounted in such a pose that the longitudinal direction of the battery 80 intersects with the up-down direction at a large angle, and the support housing 30 and the battery 80 can also be downsized in the up-down direction.

Further, according to the sander 10, the support housing 30 is located on the lower side with respect to the upper surface 21a of the main housing 20 in the up-down direction. Therefore, the battery 80 can be disposed in a space defined due to a step generated in the up-down direction between the main housing 20 and the support housing 30. Therefore, the support housing 30 and the battery 80 can be further downsized in the up-down direction with the battery 80 mounted. In addition, the support housing 30 is located on the lower side with respect to the upper end 52 of the motor shaft 51 in the up-down direction. Therefore, the above-described step increases. Accordingly, the support housing 30 and the battery 80 can be further downsized in the up-down direction. In addition, the upper end surface of the battery 80 is located on the lower side with respect to the upper surface 21a of the main housing 20 in the up-down direction with the battery 80 mounted. Therefore, the battery 80 can be completely contained in the space generated due to the above-described step. Accordingly, the support housing 30 and the battery 80 can be further downsized in the up-down direction. According to the present embodiment, the height of the sander 10 in the up-down direction can be reduced to, for example, 125 mm.

Further, according to the sander 10, the controller 90 is disposed in a dead space below the terminal assembly 70 in the support housing 30. Therefore, the sander 10 is prevented from increasing in size due to the layout of the controller 90. Further, in addition, the controller 90 is disposed so as to face the terminal block 72 of the terminal assembly 70, and therefore the terminal assembly 70 and the controller 90 can be disposed in a manner downsizing in the up-down direction.

Further, according to the sander 10, the battery 80 is disposed in such a manner that the longitudinal direction of the battery 80 extends in parallel with the front-rear direction, and is located at a position where the battery 80 does not protrude outward beyond the pad 40 in the left-right direction as viewed in the up-down direction, with the battery 80 mounted. Therefore, when the sander 10 is in use, even moving the pad 40 closer to an obstacle such as a wall does not cause interference of the battery 80 with the obstacle. Therefore, sanding work can be performed even at a location close to the obstacle.

Further, according to the sander 10, the battery 80 and the pad 40 partially overlap each other as viewed in the up-down direction with the battery 80 mounted. Therefore, the center of gravity of the sander 10 is located closer to the pad 40 with the battery 80 mounted, compared with a configuration in which the battery 80 is entirely located on the rear side with respect to the pad 40. Therefore, the user can further stably perform sanding work while gripping the housing upper portion 21.

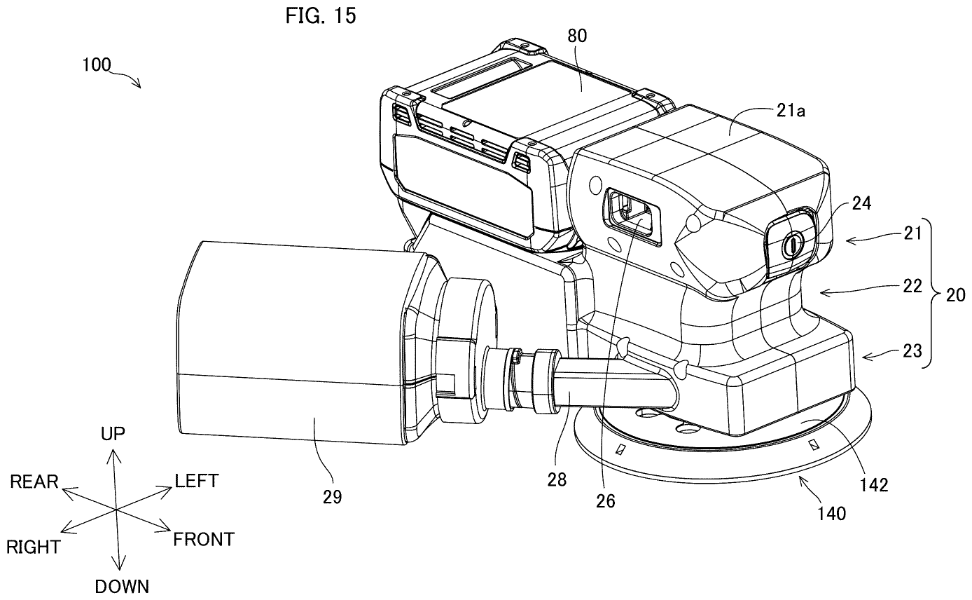

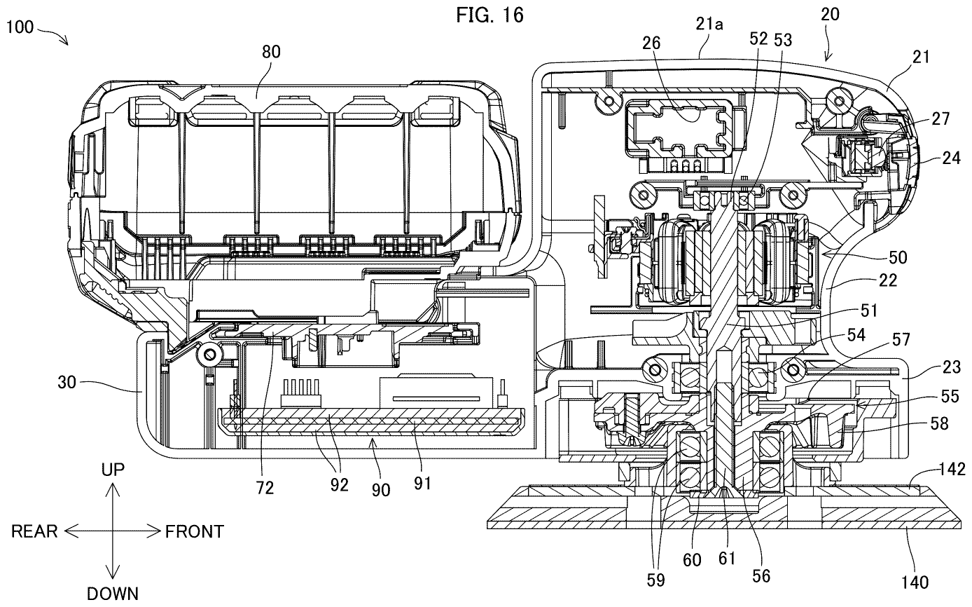

In the following description, a sander 100 according to a non-limiting second embodiment will be described with reference to FIGS. 15 and 16. In the following description, the second embodiment will be described focusing only on differences from the first embodiment. In FIGS. 15 and 16, similar components to the first embodiment are identified by the same reference numerals as the first embodiment. The sander 100 is a random orbital sander. The sander 100 includes a generally circular pad 140 and an upper plate portion 142. As illustrated in FIG. 16, the sander 100 does not include the connector 62. Therefore, when the motor 50 is driven, the pad 140 performs a rotational motion and an eccentric circular motion. In other words, the pad 140 rotates itself, and moves as if drawing a circle along the horizontal plane.

The sander 100 includes the main housing 20, the support housing 30, the terminal assembly 70, the battery 80, and the controller 90 each of which has the configuration and the layout similar to the sander 10. Therefore, the sander 100 can also bring about the various advantageous effects described above regarding the sander 10.

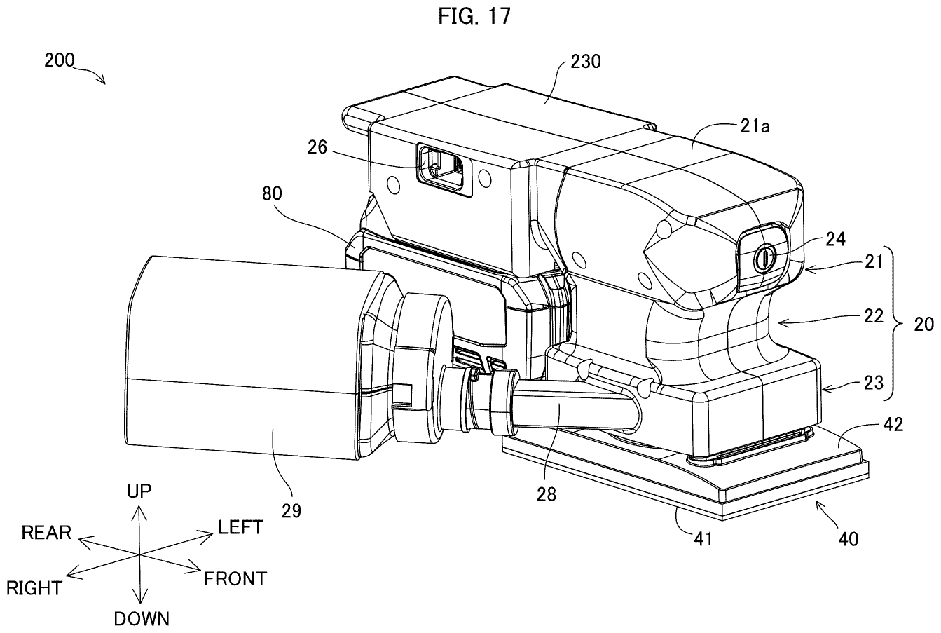

In the following description, a sander 200 according to a non-limiting third embodiment will be described with reference to FIGS. 17 to 19. In the following description, the third embodiment will be described focusing only on differences from the first embodiment. In FIGS. 17 to 19, similar components to the first embodiment are identified by the same reference numerals as the first embodiment. As illustrated in FIG. 17, the sander 200 includes a support housing 230 instead of the support housing 30 according to the first embodiment. The support housing 230 extends rearward from the housing upper portion 21. The upper surface of the support housing 230 is located at approximately the same height as the upper surface 21a of the main housing 20, and no step is generated between the support housing 230 and the main housing 20. In the present embodiment, the electric connection portion 26 is provided on the right surface of the support housing 230.

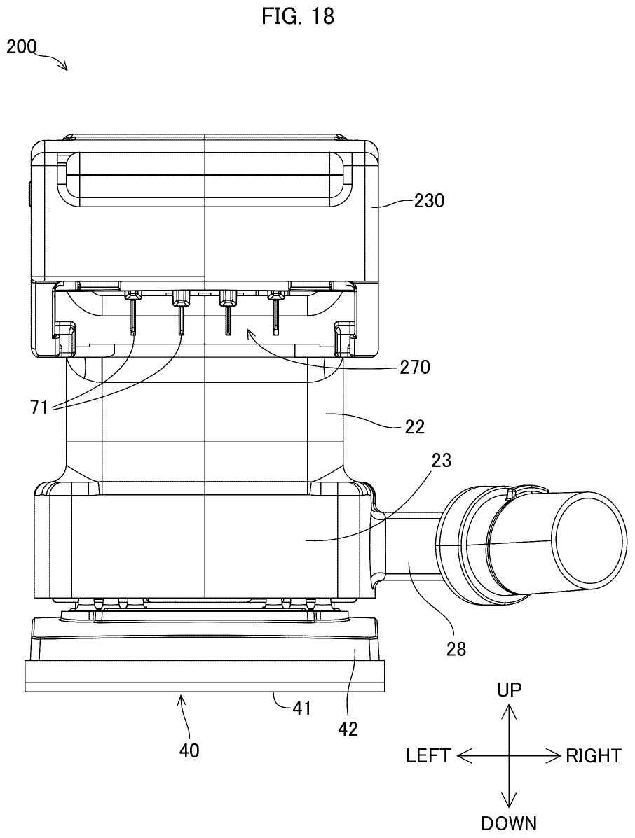

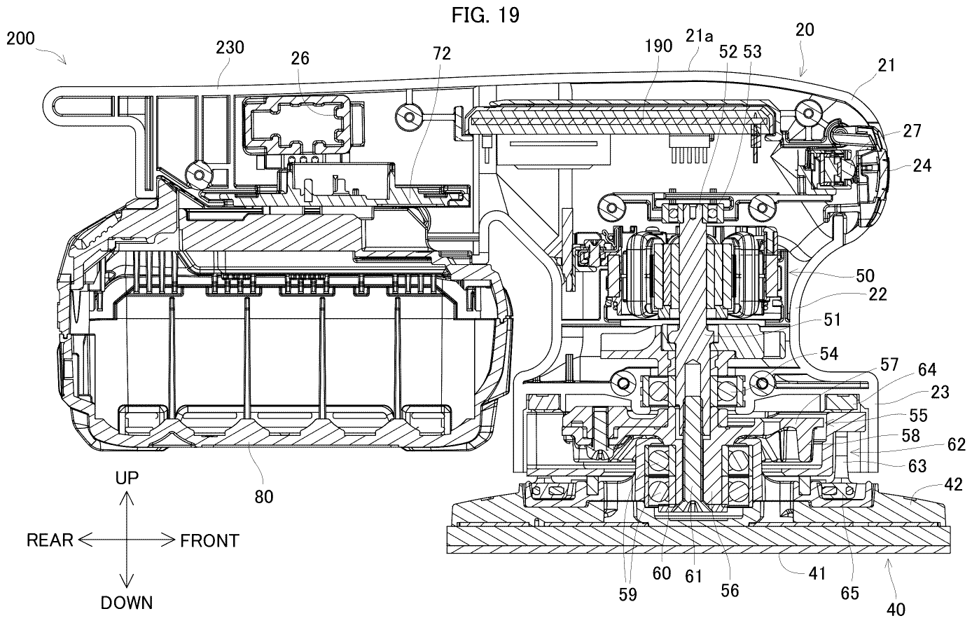

As illustrated in FIG. 18, the sander 200 includes a terminal assembly 270 instead of the terminal assembly 70 according to the first embodiment. The support housing 230 supports the terminal assembly 270 so as to be exposed on the lower side thereof. The terminal assembly 270 is configured similarly to the terminal assembly 70 according to the first embodiment. However, the terminal assembly 270 is disposed upside down compared with the terminal assembly 70. Therefore, as illustrated in FIGS. 17 and 19, the battery 80 is mounted on the support housing 230 so as to be located right below the support housing 230.

As illustrated in FIG. 19, the sander 200 includes a controller 190 instead of the controller 90 according to the first embodiment. The controller 190 is configured similarly to the controller 90. However, the controller 190 is disposed differently from the first embodiment. More specifically, the controller 190 is contained in the housing upper portion 21 so as to be located right above the motor 50. Therefore, the height of the support housing 230 can be reduced compared with the first embodiment. This results in an increase in the space below the support housing 230, thereby contributing to a reduction in constraints on the size of the mountable battery 80.

According to the sander 200, the main housing 20 can be downsized in the up-down direction similarly to the first embodiment. Further, according to the sander 200, the battery 80 as a heavy member (and thus the center of gravity of the sander 200) is located closer to the pad 40 in the up-down direction compared with the first embodiment. Therefore, the usability at the time of sanding work can be improved.

Having described the embodiments, the above-described embodiments are intended to only facilitate the understanding of the present invention, and are not intended to limit the present invention thereto. The present invention can be modified or improved without departing from the spirit thereof, and the present invention includes equivalents thereof. Further, each of the elements described in the claims and the specification can be combined in any manner or omitted in any manner within a range that allows it to remain capable of achieving at least a part of the above-described objects or bringing about at least a part of the above-described advantageous effects.

The corresponding relationship between each component in the above-described embodiments and each component of the claims will be described below. However, each component in the embodiments is merely one example and shall not limit each component of the present invention. The sanders 10 and 100 are one example of a “sander”. The attachment surface 41 is one example of an “attachment surface”. The pads 40 and 140 are one example of a “pad”. The motor 50 is one example of a “motor”. The motor shaft 51 is one example of a “motor shaft”. The main housing 20 is one example of a “main housing”. The terminal assembly 70 is one example of a “terminal assembly”. The terminal 71 is one example of a “terminal”. The terminal block 72 is one example of a “terminal block”. The support housing 30 is one example of a “support housing”. The controller 90 is one example of a “controller”. The battery 80 is one example of a “battery”. The dust nozzle 28 is one example of a “dust nozzle”.

### DESCRIPTION OF THE REFERENCE NUMERALS

10, 100, 200 sander, 20 main housing, 21 housing upper portion, 21a upper surface, 22 housing central portion, 23 housing lower portion, 24 switch button, 25 speed change dial, 26 electric connection portion, 27 switch unit, 28 dust nozzle, 29 dust bag, 30, 230 support housing, 31 placement surface, 32 guide rail, 40,140 pad, 41 attachment surface, 42 base, 43 through-hole, 50 motor, 51 motor shaft, 52 upper end, 53, 54 bearing, 55 dust collection fan, 56 shaft portion, 57 main plate, 58 blade, 59 bearing, 60 plate, 61 countersunk screw, 62 connector, 63 foot portion, 64 upper plate, 65 lower plate, 70, 270 terminal assembly, 71 terminal, 72 terminal block, 80 battery, 81 guide groove, 82 terminal connection groove, 83 mounting surface, 90, 190 controller, 91 circuit board, 92 case, 142 upper plate portion

1. A sander comprising:
a pad including an attachment surface for attaching sanding paper, and configured to perform an eccentric circular motion;
a motor including a motor shaft extending in a direction orthogonal to the attachment surface, and configured to provide a driving force to the pad;
a main housing located above the pad and containing the motor therein, an up-down direction being defined to be a direction in which the motor shaft extends, a lower side being defined to be one side in the up-down direction on which the pad is located, and an upper side being defined to be the other side in the up-down direction on which the motor is located;
a terminal assembly including a terminal block and a terminal supported on the terminal block so as to be partially exposed outward and electrically connectable to a battery, the terminal extending upward from the terminal block; and
a support housing protruding from the main housing outward in a direction orthogonal to the up-down direction, and supporting the terminal assembly.

2. The sander according to claim 1, wherein the support housing is located on the lower side with respect to an upper surface of the main housing in the up-down direction.

3. The sander according to claim 1, wherein the support housing is located on the lower side with respect to an upper end of the motor shaft in the up-down direction.

4. The sander according to claim 1, wherein the terminal extends from the terminal block in parallel with the up-down direction.

5. The sander according to claim 1, further comprising a controller contained in the support housing so as to be located below the terminal assembly, the controller being configured to control an operation of the sander.

6. The sander according to claim 5, wherein the controller is disposed so as to face the terminal block of the terminal assembly.

7. The sander according to claim 1, further comprising the battery.

8. The sander according to claim 7, wherein an upper end surface of the battery is located on the lower side with respect to an upper surface of the main housing in the up-down direction with the battery electrically connected to the terminal of the terminal assembly.

9. The sander according to claim 7, wherein a longitudinal direction of the battery extends in parallel with a front-rear direction and the battery is located at a position where the battery does not protrude outward beyond the pad in a left-right direction as viewed in the up-down direction, with the battery electrically connected to the terminal of the terminal assembly, the front-rear direction being defined to be a direction in which the main housing and the support housing are arranged, and the left-right direction being defined to be a direction orthogonal to the up-down direction and the front-rear direction.

10. The sander according to claim 1, further comprising a dust nozzle extending from the main housing,
wherein the dust nozzle is located at a position where the dust nozzle does not overlap the battery as viewed in the up-down direction with the battery electrically connected to the terminal of the terminal assembly.

11. The sander according to claim 10, wherein the dust nozzle is located at a position where the dust nozzle at least partially overlaps the support housing as viewed in the direction orthogonal to the up-down direction.

12. The sander according to claim 10, further comprising a controller contained in the support housing so as to be located below the terminal assembly, the controller being configured to control an operation of the sander, wherein the dust nozzle is located at a position where the dust nozzle at least partially overlaps the controller as viewed in the direction orthogonal to the up-down direction.

13. The sander according to claim 10, further comprising a controller contained in the support housing so as to be located below the terminal assembly, the controller being configured to control an operation of the sander,
wherein, as viewed in the up-down direction, the dust nozzle extends in a direction intersecting with the direction in which the motor and the controller are arranged or is offset from the support housing in the direction orthogonal to the direction in which the motor and the controller are arranged.

14. The sander according to claim 7, wherein the battery and the pad partially overlap each other as viewed in the up-down direction with the battery electrically connected to the terminal of the terminal assembly.

15. The sander according to claim 1, wherein the support housing is located on the lower side with respect to an upper surface of the main housing in the up-down direction, and
the support housing is located on the lower side with respect to an upper end of the motor shaft in the up-down direction.

16. The sander according to claim 7, wherein an upper end surface of the battery is located on the lower side with respect to an upper surface of the main housing in the up-down direction with the battery electrically connected to the terminal of the terminal assembly, and
a longitudinal direction of the battery extends in parallel with a front-rear direction and the battery is located at a position where the battery does not protrude outward beyond the pad in a left-right direction as viewed in the up-down direction, with the battery electrically connected to the terminal of the terminal assembly, the front-rear direction being defined to be a direction in which the main housing and the support housing are arranged, and the left-right direction being defined to be a direction orthogonal to the up-down direction and the front-rear direction.

17. The sander according to claim 7, wherein an upper end surface of the battery is located on the lower side with respect to an upper surface of the main housing in the up-down direction with the battery electrically connected to the terminal of the terminal assembly,
a longitudinal direction of the battery extends in parallel with a front-rear direction and the battery is located at a position where the battery does not protrude outward beyond the pad in a left-right direction as viewed in the up-down direction, with the battery electrically connected to the terminal of the terminal assembly, the front-rear direction being defined to be a direction in which the main housing and the support housing are arranged, and the left-right direction being defined to be a direction orthogonal to the up-down direction and the front-rear direction, and
the battery and the pad partially overlap each other as viewed in the up-down direction with the battery electrically connected to the terminal of the terminal assembly.

18. The sander according to claim 10, further comprising a controller contained in the support housing so as to be located below the terminal assembly, the controller being configured to control an operation of the sander,
wherein the dust nozzle is located at a position where the dust nozzle at least partially overlaps each of the support housing and the controller as viewed in the direction orthogonal to the up-down direction.

19. The sander according to claim 10, further comprising a controller contained in the support housing so as to be located below the terminal assembly, the controller being configured to control an operation of the sander,
wherein the dust nozzle is located at a position where the dust nozzle at least partially overlaps each of the support housing and the controller as viewed in the direction orthogonal to the up-down direction, and
as viewed in the up-down direction, the dust nozzle extends in a direction intersecting with the direction in which the motor and the controller are arranged or is offset from the support housing in the direction orthogonal to the direction in which the motor and the controller are arranged.
